(19) United States
(12) Patent Application Publication
(10) Pub. No.: US 2025/0292420 A1
(43) Pub. Date: Sep. 18, 2025

(54) ADAPTIVE DEPTH PROCESSING

(71) Applicant: QUALCOMM Incorporated, San Diego, CA (US)

(72) Inventors: Swapnesh Kumar SAHOO, Bengaluru (IN); Nitin BANDWAR, San Diego, CA (US); Aravind BHASKARA, San Diego, CA (US); Tauseef KAZI, San Diego, CA (US); Tomer LIVNEH, Pardes Hana - Karkur (IL); Eran SCHARAM, Misgav (IL); Esther TOLEDANO, Kiryat Yam (IL)

(21) Appl. No.: 18/605,441

(22) Filed: Mar. 14, 2024

(51) Int. Cl. G06T 7/50

(52) U.S. Cl. CPC G06T 7/50

(57) ABSTRACT

Systems and techniques are described herein for processing images. For instance, a method for processing images is provided. The method may include obtaining scene information based on a scene; determining a depth scheme from among a plurality of depth schemes based on the scene information; using the depth scheme to obtain depth information of the scene; and processing an image of the scene based on the depth information.

### TECHNICAL FIELD

The present disclosure generally relates to depth information. For example, aspects of the present disclosure include systems and techniques for adaptive depth processing using one or more techniques or schemes for obtaining depth information.

### BACKGROUND

Many devices can capture a representation of a scene by generating image data (e.g., images or image frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses. Some image and/or video modification techniques modify image data based on distances between a device which captured the image data (e.g., a camera) and points in a scene represented by the image data. The distances may be referred to as “depths” or “depth information.”

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing images. According to at least one example, a method is provided for processing images. The method includes: obtaining scene information based on a scene; determining a depth scheme from among a plurality of depth schemes based on the scene information; using the depth scheme to obtain depth information of the scene; and processing an image of the scene based on the depth information.

In another example, an apparatus for processing images is provided that includes at least one memory and at least one processor (e.g., configured in circuitry) coupled to the at least one memory. The at least one processor configured to: obtain scene information based on a scene; determine a depth scheme from among a plurality of depth schemes based on the scene information; use the depth scheme to obtain depth information of the scene; and process an image of the scene based on the depth information.

In another example, a non-transitory computer-readable medium is provided that has stored thereon instructions that, when executed by one or more processors, cause the one or more processors to: obtain scene information based on a scene; determine a depth scheme from among a plurality of depth schemes based on the scene information; use the depth scheme to obtain depth information of the scene; and process an image of the scene based on the depth information.

In another example, an apparatus for processing images is provided. The apparatus includes: means for obtaining scene information based on a scene; means for determining a depth scheme from among a plurality of depth schemes based on the scene information; means for using the depth scheme to obtain depth information of the scene; and means for processing an image of the scene based on the depth information.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating an example camera and an example object at a first depth within a scene;

FIG. 1B is a diagram illustrating the example camera of FIG. 1A and an example object at a depth within a scene;

FIG. 1C is a diagram illustrating the example camera of FIG. 1A and an example object at a depth within a scene;

FIG. 2 illustrates two example images, that may be used to determine depth information according to a depth-from-stereo (DFS) depth-estimation technique;

FIG. 3 illustrates two example images and an example associated cost function, according to various aspects of the present disclosure;

FIG. 4 is a diagram illustrating an example projection-based depth-estimation system, according to various aspects of the present disclosure;

FIG. 5 is a depiction of an example structured light depth-sensing system, according to various aspects of the present disclosure;

FIG. 6 is a block diagram of an example system for generating depth information using a machine-learning model, according to various aspects of the present disclosure;

FIG. 7A is a block diagram illustrating an example system that may adaptively determine a depth scheme to use to determine depth information of a scene, according to various aspects of the present disclosure;

FIG. 7B is a block diagram of an example system that may adaptively determine a depth scheme to use to determine depth information of scene, according to various aspects of the present disclosure;

FIG. 7C is a block diagram of an example system that may adaptively determine a depth scheme to use to determine depth information of scene, according to various aspects of the present disclosure;

FIG. 8 includes five images of a scene to illustrate various aspects of the present disclosure;

FIG. 9 is a flow diagram illustrating another example process for modifying images based on depth information, in accordance with aspects of the present disclosure;

FIG. 10 is a block diagram illustrating an example of a deep learning neural network that can be used to perform various tasks, according to some aspects of the disclosed technology;

FIG. 11 is a block diagram illustrating an example of a convolutional neural network (CNN), according to various aspects of the present disclosure; and

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Depth information may be used for various purposes. For instance, as noted above, some image and/or video modification techniques modify image data based on distances (or depths) between a device which captured the image data (e.g., a camera) and points in a scene represented by the image data. In one example, an artificial greenscreen technique may include obtaining depth information and using the depth information to determine foreground image pixels that represent objects in a foreground of a scene and background image pixels that represent objects in a background of the scene. The artificial greenscreen technique may replace background image pixels with other pixels of another image such that objects in the foreground of the image appear to be in front of the other image. As another example, an artificial-bokeh technique may include obtaining depth information and identifying foreground image pixels and background image pixels. The artificial-bokch technique may include blurring the background image pixels which may cause the foreground image pixels to stand out. As another example, a color-adjusting technique may include obtaining depth information and identifying foreground image pixels and background image pixels. The color-adjusting technique may suppress or enhance luma and/or chroma values of either the foreground pixels or background pixels.

Depth information may be determined according to a depth mode. There are multiple depth modes that can be used to determine depth information. A single device may be capable of generating depth information according to two or more depth modes.

One example of a depth mode is a phase-detection (PD) autofocus-based depth-estimation mode or technique. For example, according to a PD autofocus-based depth-estimation technique, a device may capture light using two separate sets of photodiodes (or pixels), including image pixels and PD pixels. The device may compare the light as received at the image pixels and the PD pixels to determine how the lens is focused relative to points in the scene. The device may determine depths to the points in the scene (e.g., depth information) based on how the lens is focused relative to the points in the scene.

Another example of a depth mode is a depth-from-stereo (DFS) depth-determination mode or technique. For instance, according to a DFS depth-determination technique, a device may capture two (or more) image of a scene from cameras that are positioned a predetermined distance apart. The device may triangulate depths to points in the scene (e.g., depth information) based on the position of representations of the points in the two images and the predetermined distance.

Time-of-flight (ToF) depth-determination is another example of a depth mode or technique. For example, according to a ToF depth-determination technique, a device may project light into a scene, receive the light as it is reflected from points in the scene, and determine depths of the points in the scene (e.g., depth information) based on the timing of projection and reception of the light.

Another example is an active-illumination depth-determination mode or technique. To perform active-illumination depth-determination, a device may illuminate a scene with patterned light (e.g., a pattern of dots) projected by a projector. The device may capture an image of the scene at a camera that is a predetermined distance from the projector. The device may triangulate depths to points in the scene (e.g., depth information) based on how the patterned light appears in the image of the scene and the predetermined distance.

Machine-learning-model-based depth-estimation modes also may be used to determine depth information. For instance, according to an example machine-learning-model-based depth-estimation technique, a device may capture an image and provide the captured image to a machine-learning model. The machine-learning model may be trained to generate depth information based on images. The machine-learning model may generate depth information based on the provided image. A machine-learning-model-based depth-estimation technique is an example of a monocular depth-estimation technique.

Various depth modes (such as the examples provided above) may use different amounts of resources, including, power, computation time, and/or communication bandwidth. For example, it may be more computationally expensive to determine depth information using a DFS technique than using a PD-based technique.

Additionally or alternatively, various depth modes may have different accuracies, depth-information-determination rates, and/or perform differently based on characteristics of the scene. For example, various depth modes may perform differently based on motion within the scene and/or lighting within the scene.

Systems, apparatuses, methods (also referred to as processes), and computer-readable media (collectively referred to herein as “systems and techniques”) are described herein for adaptively selecting depth schemes for modifying image data based on scene information. In the present disclosure, the term “depth scheme” may refer to using one or more depth modes to determine depth information. For example, a first depth scheme may use a first depth mode (e.g., a PD-based technique) to determine depth information. A second depth scheme may use a second depth mode (e.g., a DFS technique) to determine depth information. A third depth scheme may use both the first and the second depth modes to determine depth information. For example, the third depth scheme may determine depth values based on averages of depth values obtained by the first depth mode and the second depth mode.

According to some aspects, the systems and techniques may obtain scene information including information associated with a scene. The systems and techniques may determine a depth scheme to use to generate depth information of the scene based on the scene information, for example, such that the depth scheme is appropriate to the scene and/or subjects in the scene. Examples of scene information, on which the systems and techniques may determine depth schemes, include subject information, subject-depth information, subject-depth-confidence information, depth-confidence information, global-motion information, local-motion information, lighting information, any combination thereof, and/or other information. The systems and techniques may obtain depth information according to the depth scheme. Further, the systems and techniques may modify images of the scene (e.g., video data) based on the depth information.

The systems and techniques may continue to obtain scene information and may update depth-scheme determinations over time (e.g., adaptively selecting depth schemes). For example, at a first time, the systems and techniques may obtain first scene information and determine a first depth scheme based on the first scene information. The systems and techniques may determine first depth information using the first depth scheme and may modify one or more images based on the first depth information. At a second time, the systems and techniques may obtain second scene information. The scene may have changed between the first time and the second time. Based on the change, the systems and techniques may determine a second depth scheme that is different than the first depth scheme. The systems and techniques may determine second depth information using the second depth scheme and may modify one or more images based on the second depth information.

In some aspects, the systems and techniques may select depth schemes to conserve computational resources. Some depth-determination modes may be more computationally expensive than other depth modes. The systems and techniques may determine to use less computationally-expensive depth-determination modes when it is possible to use a less computationally-expensive depth-determination mode while determining depth information of sufficient quality. For example, in instances in which subjects in a scene are stationary and depth information of the subjects has already been determined, the systems and techniques may determine to use a less computationally-expensive depth-determination mode to conserve power.

Additionally or alternatively, the systems and techniques may select depth schemes to improve accuracy of depth information. For example, some depth-determination modes may work poorly in low-light scenes. The systems and techniques may determine to not use such depth determination modes in low-light scenes.

Various aspects of the application will be described with respect to the figures below.

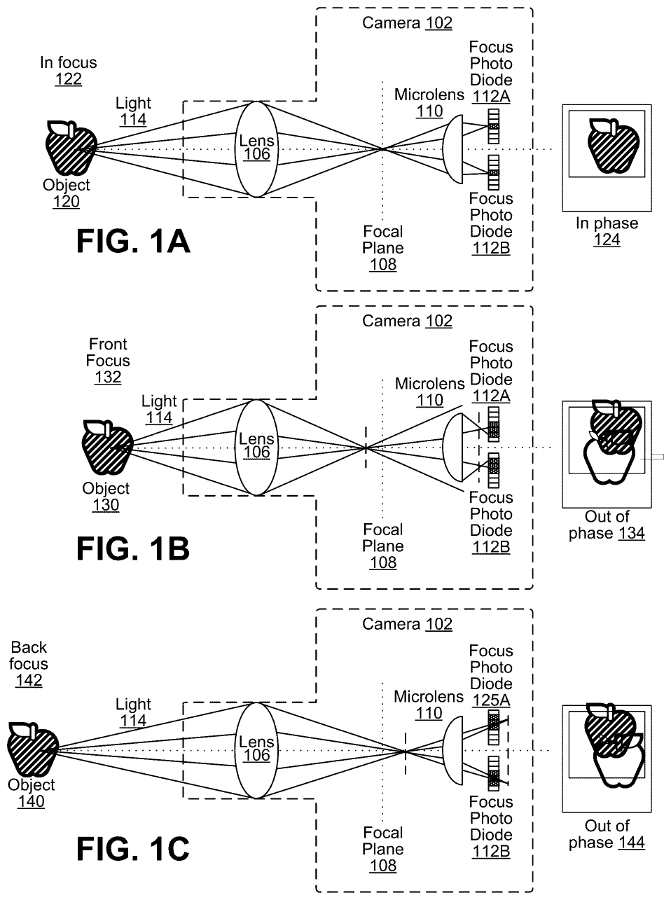

For example, FIG. 1A is a diagram illustrating an example camera 102 and an example object 120 (e.g., an apple) at a first depth 122 within a scene. Rays of light 114 may travel from object 120 through a lens 106. Lens 106 may focus light from the scene onto an image sensor (not pictured in its entirety). The image sensor includes photodiode 112a and photodiode 112b, which correspond to focus pixels. Photodiode 112a and photodiode 112b may be associated with one or two focus pixels (e.g., photodiode 112a and photodiode 112b may be two photodiodes of a single focus pixel sharing a single microlens 110 or photodiode 112a may be associated with a first focus pixel and photodiode 112b may be associated with a second focus pixel, both focus pixels sharing a single microlens 110) of the pixel array of the image sensor. In some cases, light 114 may travel through a microlens 110 before falling on photodiode 112a and photodiode 112b.

At first depth 122 within the scene, object 120 is “in focus” or in an “in focus state” based on the position of lens 106 relative to the image senor (and/or based on the position and focal length of microlens 110). As illustrated FIG. 1A, the rays of light 114 may converge at a plane that corresponds to the position of photodiode 112a and photodiode 112b. When object 120 is in focus (e.g., when object 120 is at depth 122), rays of light 114 may also converge at a focal plane 108 (also known as an image plane) after passing through lens 106 but before reaching microlens 110 and/or photodiode 112a and photodiode 112b.

Because object 120, at depth 122, is in focus, data from photodiode 112a and photodiode 112b is aligned. The alignment of the data from focus photodiodes is represented by an image 124 showing a clear and sharp representation of object 120 due to the alignment. The in-focus state may also be referred to as an “in-phase” state, as the data from photodiode 112a and photodiode 112b have no phase disparity, or have very little phase disparity (e.g., phase disparity falling below a predetermined phase disparity threshold).

FIG. 1B is a diagram illustrating camera 102 and an example object 130 at a depth 132 within a scene. At depth 132, object 130 is out of focus. Camera 102 of FIG. 1B may be the same as camera 102 of FIG. 1A, and lens 106 may be in the same position in camera 102 of FIG. 1A and camera 102 of FIG. 1B. Object 130, at depth 132 may be closer to lens 106 than object 120 is at depth 122. Therefore object 130 may be in a “front focus” state.

With object 130 in the “front focus” state (as illustrated by FIG. 1B), the rays of light 114 may ultimately converge at a plane (denoted by a dashed line) before the position of photodiode 112a and photodiode 112b, that is, between microlens 110 and photodiode 112a and photodiode 112b. The rays of light 114 may also converge at a position (denoted by another dashed line) before focal plane 108 after passing through lens 106 but before reaching microlens 110 and/or photodiode 112a and photodiode 112b. Because the rays of light 114 in camera 102 of FIG. 1B is out of phase in the “front focus” state, data from photodiode 112a and photodiode 112b is misaligned, here represented by an image 134 showing misaligned representations of object 130, where the direction of misalignment in image 134 is related to the front focus depth 122, and the distance of misalignment in image 134 is related to the distance of lens 106 from its position in the focused state.

FIG. 1C is a diagram illustrating camera 102 and an example object 140 at a depth 142 within a scene. At depth 142, object 140 is out of focus. Camera 102 of FIG. 1C may be the same as camera 102 of FIG. 1A, and lens 106 may be in the same position in camera 102 of FIG. 1A and camera 102 of FIG. 1C. Object 140, at depth 142 may be farther from lens 106 than object 120 is at depth 122. Therefore object 140 may be in a “back focus” state (also known as a “rear focus” state).

When object 140 is in the “back focus” state (as illustrated by FIG. 1C), the rays of light 114 may converge at a plane (denoted by a dashed line) beyond the position of photodiode 112a and photodiode 112b. The rays of light 114 may also converge at a position (denoted by another dashed line) beyond focal plane 108 after passing through lens 106 but before reaching microlens 110 and/or photodiode 112a and photodiode 112b. Because the rays of light 114 in camera 102 of FIG. 1C is out of phase in the “back focus” state, data from photodiode 112a and photodiode 112b is misaligned, here represented by an image 144 showing misaligned representations of object 140, where the direction of misalignment in image 144 is related to the back focus state, and the distance of misalignment in image 144 is related to the distance of lens 106 from its position in the focused state.

When the rays of light 114 converge before the plane of photodiode 112a and photodiode 112b as in the front focus state illustrated by FIG. 1B, or beyond the plane of photodiode 112a and photodiode 112b as in the back focus state illustrated by FIG. 1C, the resulting image produced by the image sensor may be out-of-focus or blurred. In the case that the image is in the front focus state (as illustrated by FIG. 1B), lens 106 can be moved forward (toward the subject and away from photodiode 112a and photodiode 112b). If lens 106 is in the back focus state (as illustrated by FIG. 1C), lens 106 can be moved backward (away from the subject and toward photodiode 112a and photodiode 112b). Focusing a lens based on the phase differences described with regard to FIG. 1B and FIG. 1C may be referred to as Phase Detection Autofocus (PDAF).

Additionally or alternatively, the out of focus state of pixels representing objects can be used to determine the depth of the objects in the scene. For example, based on a known focal length of lens 106, camera 102 may determine depth 122 of object 120 based on image 124 being in focus. Additionally or alternatively, camera 102 may determine depth 132 based on image 134 (e.g., based on the details of how image 134 is out of focus). Further camera 102 may determine depth 142 based on image 144 (e.g., based on the details of how image 144 is out of focus).

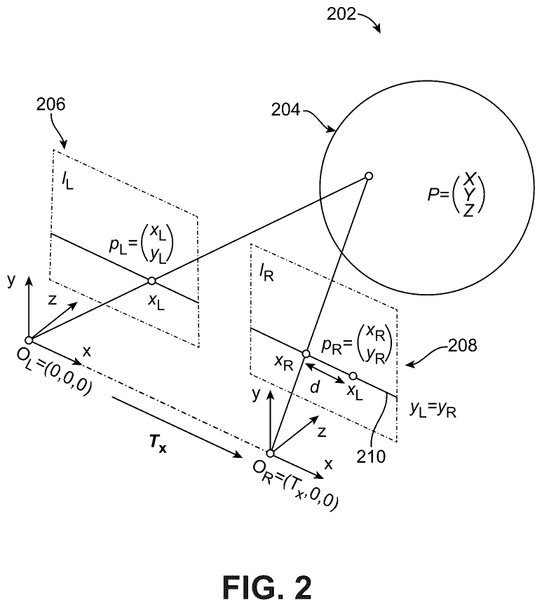

FIG. 2 illustrates two example images, that may be used to determine depth information according to a depth-from-stereo (DFS) depth-estimation technique. DFS depth-estimation may be an example of a keypoint-matching-based depth-estimation technique.

FIG. 2 illustrates image 206 and image 208 (also denoted in FIG. 2 as image I_{L} and image I_{R}), of a single scene 202 captured from different camera positions, according to various aspects of the present disclosure. The different camera positions are marked as left and right “origin” points, O_{L}, and O_{R}, which are offset by a distance Tₓ. Because of the offset Tₓ, the same point P of object 204 appears at different pixel locations p_{L} and p_{R} within the two images 206 (I_{L}) and 208 (I_{R}). As can be seen, the x-axis coordinate XR in image 208 (I_{R}), corresponding to point PR in image 208 (I_{R}), is offset along epi-polar line 210 by disparity d from a coordinate x_{L}, where the coordinate x_{L} corresponds to the position of the point P in the image 206 (I_{L}). This disparity in pixel locations (also referred to as discrepancy) may be used to determine an approximate distance from the cameras to the point P on object 204 in scene 202. By knowing the stereo camera geometry and applying such an analysis to each point in the images, a depth map of the scene may be generated.

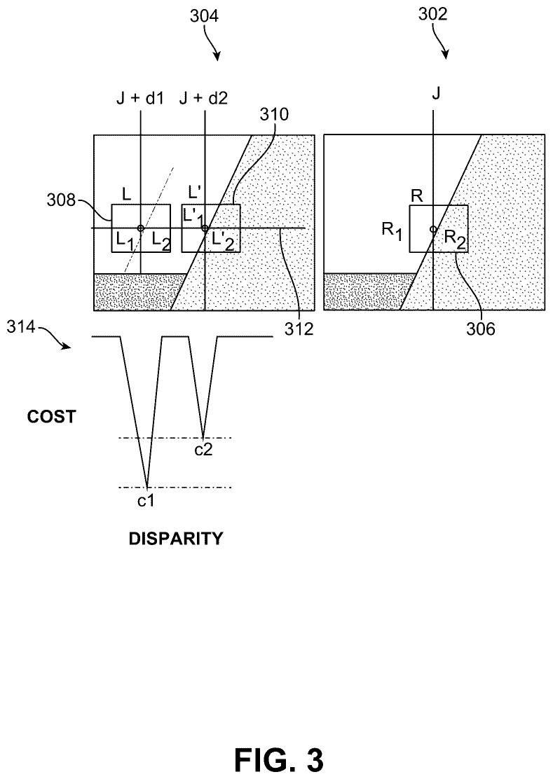

In order to determine the disparity d, a system may determine that the pixel location p_{R} in the image 208 (I_{R}) corresponds to the pixel location p_{L} in the image 206 (I_{L}), for example, by comparing a window of pixels including pixels at, and around, the pixel location p_{L} to a number of windows of pixels in image 208 (I_{R}). An example of such a window-based comparison technique is described with respect to FIG. 3. For example, a passive stereo-vision system may determine epi-polar line 210 in the image 208 (I_{R}). Epi-polar line 210 may be a defined by a ray projected from origin point O_{L} to the point P as viewed in in the image 206 (I_{R}). The passive stereo-vision system may compare the window of pixels including pixels at, and around, the pixel location p_{L} to similarly-sized windows along epi-polar line 210.

FIG. 3 illustrates two example images, image 302 (which may be a “right image” or a “reference image”) and image 304 (which may be a “left image”), and an example associated cost function 314, according to various aspects of the present disclosure. To compare windows between image 302 and image 304, a window 306 of pixels from the image 302 may be selected. Window 306 of pixels from image 302 may be compared to one or more windows of pixels from image 304. In some cases, window 306 may be compared to similarly-sized windows (e.g., all similarly-sized windows) along an cpi-polar line 312 of image 304.

The cost function 314 shown in FIG. 3 is representative of a similarity between window 306 and similarly-sized windows along epi-polar line 312 of image 304 as a function of disparity. The similarity between windows may be based on similarities between respective red, green, blue, and/or intensity (or brightness or luminance) values of pixels included in the respective windows. The lower the value of cost function 314 for a particular disparity, the higher the degree of similarity is between window 306 and a window of image 302 at the corresponding disparity. For example, cost function 314 includes two minima, c1 and c2. The minima c1 corresponds to a disparity d1, which corresponds to a comparison between window 306 and candidate window 308 of image 304. The minima c2 corresponds to a disparity d2 which corresponds to a comparison between window 306 and candidate window 310 of image 304.

A disparity map may be a two-dimensional map of disparities. The two-dimensional map may relate to an image (e.g., image 206 of FIG. 2). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 2). A depth map may be derived from a disparity map based on the three-dimensional geometry of a scene (e.g., scene 202 of FIG. 2) including a distance between the cameras which captured the images (e.g., the distance T_{X} of FIG. 2).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 206 of FIG. 2). For instance, the depth map may have a resolution that is the same or substantially the same as the corresponding image, with each depth value of the depth map representing a depth, or distance, between an origin point (e.g., origin point O_{L} of FIG. 2) and points (e.g., point P of FIG. 2). In some cases, each pixel in the depth map may have one depth value. Because a depth map is based on a disparity map, in some cases, each pixel of a disparity may have one disparity.

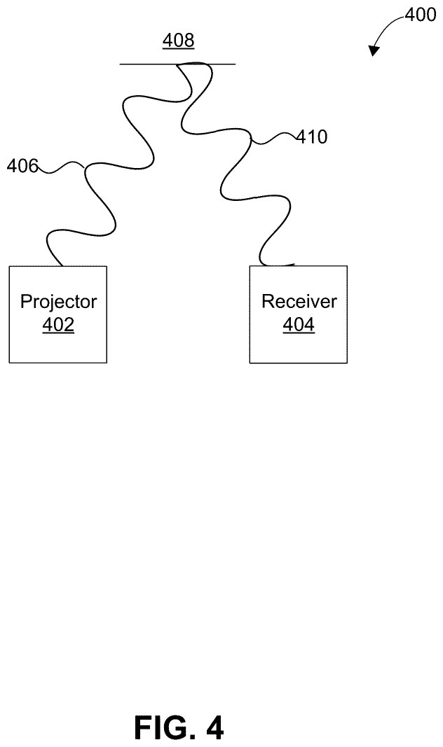

FIG. 4 is a diagram illustrating an example “projection-based” or “active” depth-estimation system (system 400), according to various aspects of the present disclosure. System 400 may be, or may include, for example, a light ranging and detection (LIDAR)-based system, a radio detection and ranging (RADAR)-based system, a direct time-of-flight (DToF) system, or an indirect time-of-flight (IToF) system.

As a LIDAR system, a RADAR system, or a dToF depth system, system 400 may measure a timing difference (e.g., a time of flight) between when emitted light pulse 406 is emitted by projector 402 and when reflected light pulse 410 received by receiver 404 (e.g., after emitted light pulse 406 has been reflected by object 408 in an environment). Although illustrated as spread apart in FIG. 4, projector 402 and receiver 404 may be collocated, beside one another, or interspersed with one another. As a LIDAR system, a RADAR system, or a dToF depth system, system 400 may, based on the time of flight and the speed of light, calculate a distance between the system 400 and object 408 in the environment. As used here, the term “light” may refer to any portion of the electromagnetic spectrum including, as examples, visible light, infrared light, and/or radio waves.

As an iToF depth camera, System 400 may measure a phase difference between emitted light pulse 406 as emitted by projector 402 and reflected light pulse 410 as received by receiver 404. System 400 may relate the phase difference to a time of flight of emitted light pulse 406 between emission and reception, based on the speed of light and the frequency of the light pulsc. As an iToF depth camera, System 400 may, based on the time of flight and the speed of light, calculate a distance between system 400 and object 408 in the environment. IToF depth cameras may experience aliasing based on the wavelength of emitted light pulse 406. Aliasing may result in multi-peak distribution profiles.

System 400 may emit one more light pulses into the environment and determine depth information relative to the environment. For example, projector 402 may emit one or more light pulses and receive and focus reflected light pulses onto an array of sensors of receiver 404. The array of depth sensors may include a number of independent depth sensors arranged as depth pixels. Each depth pixel may correspond to a ray between the depth pixel and the environment. For example, reflections along a given ray may be focused onto a given depth pixel. System 400 may store depth information recorded by various sensors as depth values of depth pixels of a depth map.

Additionally or alternatively, projector 402 and receiver 404 may scan the environment. For example, projector 402 may project emitted light pulse 406 into the environment at a given angle and receiver 404 may receive reflected light pulse 410 from the environment. Projector 402 may change angles, for example, scanning the environment, and receiver 404 may track reflected light pulse 410 from various angles of projector 402. System 400 may store depth information from various angles as depth values of depth pixels of a depth map.

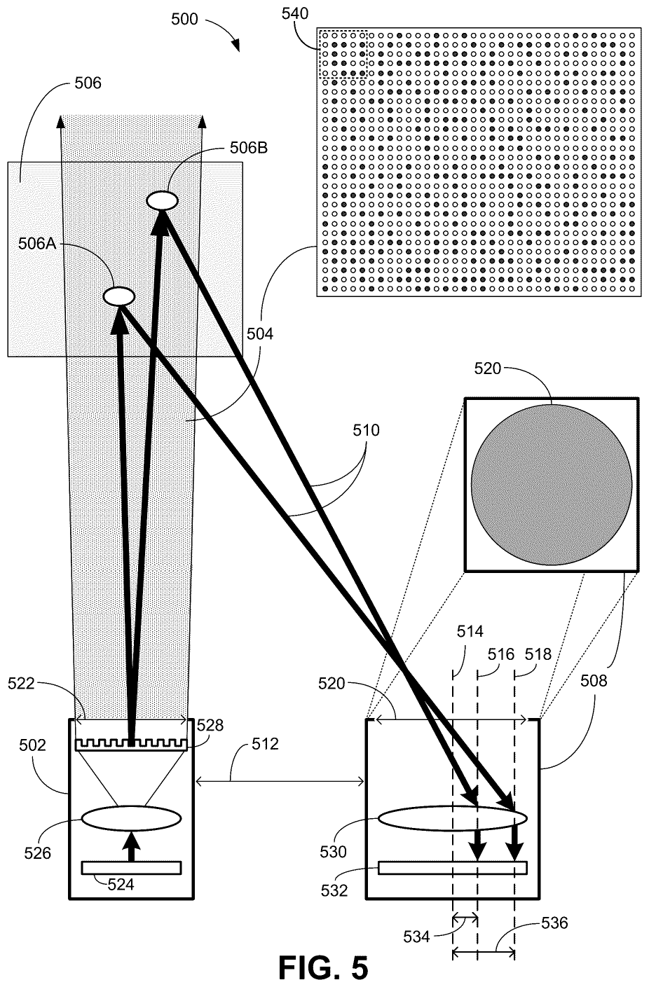

FIG. 5 is a depiction of an example structured light depth-sensing system (system 500), according to various aspects of the present disclosure. Structured-light depth-sensing (like projection-based depth sensing) is an example of active depth sensing. System 500 is an example of a keypoint-matching-based depth-estimation technique. System 500 may use a pattern 504 of dots for determining depths of objects 506A and 506B in a scene 506, according to various aspects of the present disclosure. System 500 may be used to generate a depth map (not illustrated in FIG. 5) of a scene 506. For example, the scene 506 may include an object (e.g., a face), and system 500 may be used to generate a depth map including a plurality of depth values indicating depths of portions of the object for identifying or authenticating the object (e.g., for face authentication). System 500 includes a projector 502 and a receiver 510. Projector 502 may be referred to as a “structured light source”, “transmitter,” “emitter,” “light source,” or other similar term, and should not be limited to a specific transmission component. Throughout the following disclosure, the terms projector, transmitter, and light source may be used interchangeably. Receiver 510 may be referred to as a “detector,” “sensor,” “sensing element,” “photodetector,” and so on, and should not be limited to a specific receiving component.

Projector 502 may be configured to project or transmit a pattern 504 of dots (e.g., light points or shapes) onto scene 506. The white circles in pattern 504 indicate where no light is projected, and the black circles in pattern 504 indicate where light is projected. The disclosure may alternatively refer to the pattern 504 as a codeword distribution or a distribution, where defined portions of the pattern 504 are codewords (also referred to as codes).

Projector 502 includes one or more light sources 526 (such as one or more lasers). In some implementations, the one or more light sources 526 includes a laser array. In one illustrative example, each laser may be a vertical cavity surface emitting laser (VCSEL). In another illustrative example, each laser may include a distributed feedback (DFB) laser. In another illustrative example, the one or more light sources 526 may include a resonant cavity light emitting diodes (RC-LED) array. In some implementations, the projector may also include a lens 528 and a light modulator 530. Projector 502 may also include an aperture 524 from which the transmitted light escapes projector 502. In some implementations, projector 502 may further include a diffractive optical element (DOE) to diffract the emissions from one or more light sources 526 into additional emissions. In some aspects, the light modulator 530 (which may adjust the intensity of the emission) may include a DOE.

In projecting pattern 504 of dots onto scene 506, projector 502 may transmit one or more lasers from light source 526 through lens 528 (and/or through a DOE and/or light modulator 530) and onto objects 506A and 506B in scene 506. Projector 502 may be positioned on the same reference plane as receiver 510, and projector 502 and receiver 510 may be separated by a known distance, which may be referred to as baseline 514.

In some implementations, the light projected by projector 502 may be infrared (IR) light. IR light may include portions of the visible light spectrum and/or portions of the light spectrum that is not visible to the naked eye. In one example, IR light may include near infrared (NIR) light, which may or may not include light within the visible light spectrum, and/or IR light (such as far infrared (FIR) light) which is outside the visible light spectrum. The term IR light should not be limited to light having a specific wavelength in or near the wavelength range of IR light. Further, IR light is provided as an example emission from the projector. In the following description, other suitable wavelengths of light may be used. For example, light in portions of the visible light spectrum outside the IR light wavelength range or ultraviolet (UV) light may be used.

Scene 506 may include objects at different depths from system 500 (such as from projector 502 and receiver 510). For example, objects 506A and 506B in scene 506 may be at different depths. Receiver 510 may be configured to receive, from scene 506, reflections 512 of the transmitted pattern 504 of dots. To receive reflections 512, receiver 510 may capture a frame. When capturing the frame, receiver 510 may receive reflections 512, as well as (i) other reflections of pattern 504 of dots from other portions of scene 506 at different depths, (ii) ambient light, and (iii) noise. In the present disclosure, the terms “frame” and “image” may be used interchangeably to refer to what is captured by receiver 510. The frame, or image, may or may not be, or include, a visible image but may rather include intensity values including intensities of reflections 512. The intensity values may be based on reflections 512 of visible light, IR light, or UV light.

In some implementations, receiver 510 may include a lens 532 to focus or direct the received light (including reflections 512 from the objects 506A and 506B) on to a sensor 534 of receiver 510. Receiver 510 also may include an aperture 522. Assuming for the example that only reflections 512 are received, depths of the objects 506A and 506B (e.g., distances between projector 502 or receiver 510 and objects 506A and 506B respectively) may be determined based on baseline 514 and displacement and distortion of dots of pattern 504 in reflections 512.

To compare displacement and distortion, system 500 may match dots of pattern 504 as projected by projector 502 with the dots of the pattern as captured in images at receiver 510. As such, system 500 is considered to be implementing a keypoint-matching-based depth-estimation technique.

In some cases, an intensity of reflections 512 may also be used to determine depths of objects 506A and 506B. For example, a distance 536 along sensor 534 from location 518 to a center 516 of sensor 534 may be used in determining a depth of object 506B in scene 506. Similarly, a distance 538 along sensor 534 from a location 520 to center 516 may be used in determining a depth of object 506A in scene 506. The distance along sensor 534 may be measured in terms of number of pixels of sensor 534 or a unit of distance (such as millimeters).

In some implementations, sensor 534 may include an array of photodiodes (such as avalanche photodiodes) for capturing a frame. To capture the frame, each photodiode in the array may capture the light that hits the photodiode and may provide a value indicating the intensity of the light (a capture value). The frame therefore may be an array of capture values provided by the array of photodiodes. In addition or alternative to sensor 534 including an array of photodiodes, sensor 534 may include a complementary metal-oxide semiconductor (CMOS) sensor. To capture the image by a photosensitive CMOS sensor, each pixel of the sensor may capture the light that hits the pixel and may provide a value indicating the intensity of the light. In some example implementations, an array of photodiodes may be coupled to the CMOS sensor. In this manner, the electrical impulses generated by the array of photodiodes may trigger the corresponding pixels of the CMOS sensor to provide capture values.

Sensor 534 may include at least a number of pixels equal to the number of possible dots in pattern 504. For example, the array of photodiodes or the CMOS sensor may include at least a number of photodiodes or a number of pixels, respectively, corresponding to the number of possible dots in pattern 504. In some implementations, sensor 534 may include more pixels than the number of possible dots of pattern 504. For example, in some cases, sensor 534 may include five or ten times as many pixels as pattern 504 includes dots. If light source 526 transmits IR light (such as NIR light at a wavelength of, e.g., 940 nanometers (nm)), sensor 534 may be an IR sensor to receive the reflections of the NIR light.

As illustrated, distance 536 (corresponding to a reflection 512 from object 106B) is less than distance 538 (corresponding to a reflection 512 from object 506A). Using triangulation based on baseline 514 and distance 536 and distance 538, the differing depths of objects 506A and 506B in scene 506 may be determined and a depth map of scene 506 may be generated. Determining the depths may further be based on a displacement or a distortion of pattern 504 in reflections 512.

In some implementations, projector 502 may be configured to project a fixed light distribution, in which case the same distribution of light is used in every instance for active depth sensing. In some implementations, projector 502 may be configured to project a different pattern of light at different times. For example, projector 502 may be configured to project a first pattern of light at a first time and project a second pattern of light at a second time. A resulting depth map of one or more objects in a scene may thus be based on one or more reflections of the first pattern of light and one or more reflections of the second pattern of light.

Although a number of separate components are illustrated in FIG. 5, one or more of the components may be implemented together or include additional functionality. All described components may not be required for system 500, or the functionality of components may be separated into separate components. Additional components not illustrated also may exist. For example, receiver 510 may include a bandpass filter to allow signals having a determined range of wavelengths to pass onto sensor 534 (thus filtering out signals with a wavelength outside of the range). In this manner, some incidental signals (such as ambient light) may be prevented from being received as interference during the captures by sensor 534. The range of the bandpass filter may be centered at the transmission wavelength for projector 502. For example, if projector 502 is configured to transmit NIR light with a wavelength of 940 nm, receiver 510 may include a bandpass filter configured to allow NIR light having wavelengths within a range of, for example, 920 nm to 960 nm. Therefore, the examples described regarding FIG. 5 is for illustrative purposes.

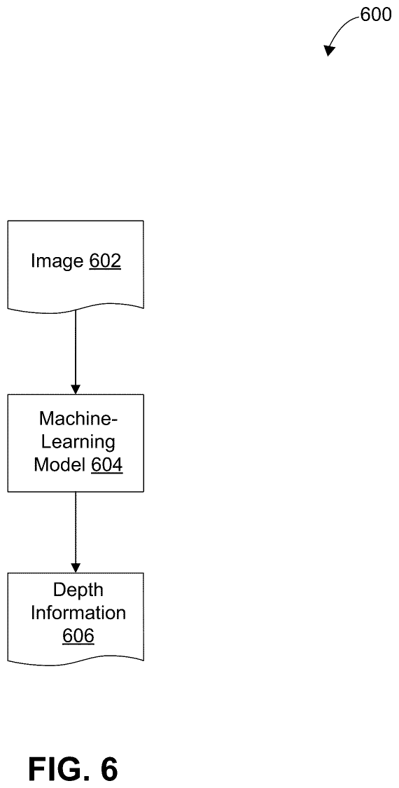

FIG. 6 is a block diagram of an example system 600 for generating depth information 606 using a machine-learning model 604, according to various aspects of the present disclosure. System 600 may obtain image 602 of a scene and provide image 602 to machine-learning model 604. Machine-learning model 604 may generate depth information 606 based on image 602.

Machine-learning model 604 may be trained (e.g., through an iterative backpropagation training process) to generate depth information based on images. For example, during a training phase, machine-learning model 604 may be provided with training image data. Machine-learning model 604 may generate provisional depth information based on the training image data. The provisional depth information may be compared with ground truth depth information and a difference (e.g., an error) between the provisional depth information and the ground truth depth information may be determined. Parameters (e.g., weights) of machine-learning model 604 may be adjusted such that in further iterations of the training process, further provisional depth information may be closer to the ground truth depth information. Machine-learning model 604 may be deployed in system 600 and may, at an inference stage of operation, be provided with image 602 and infer depth information 606 based on image 602.

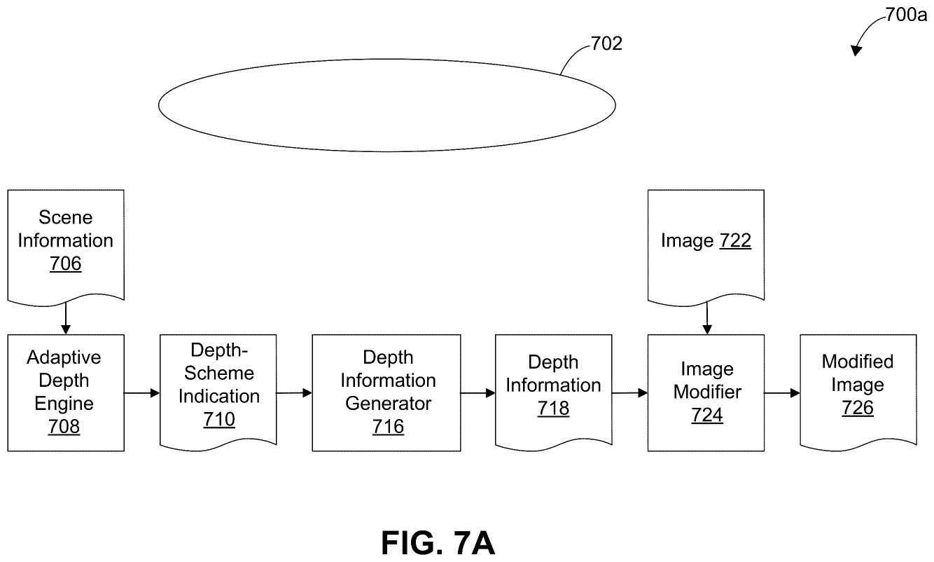

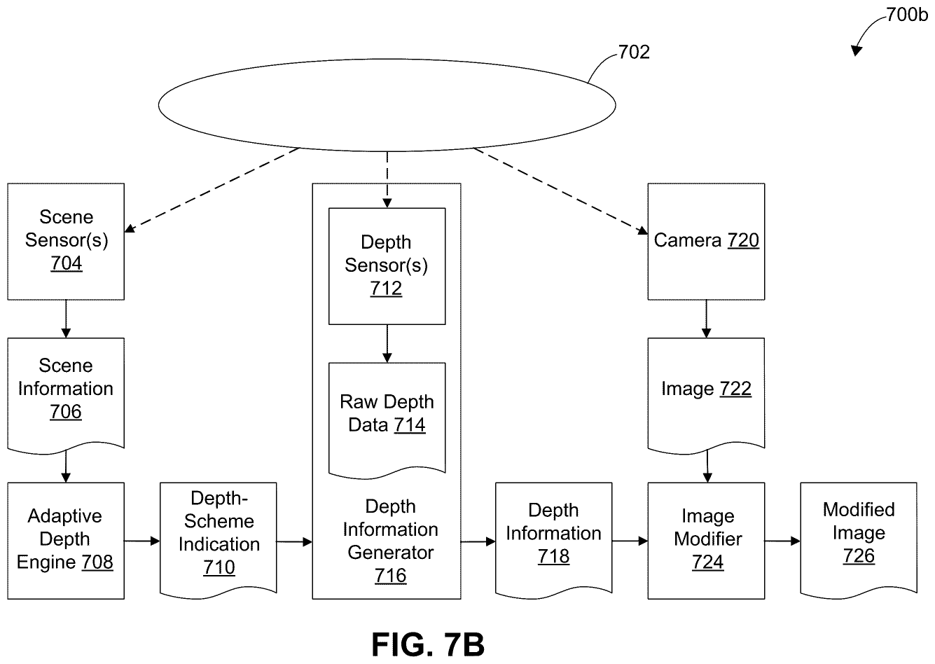

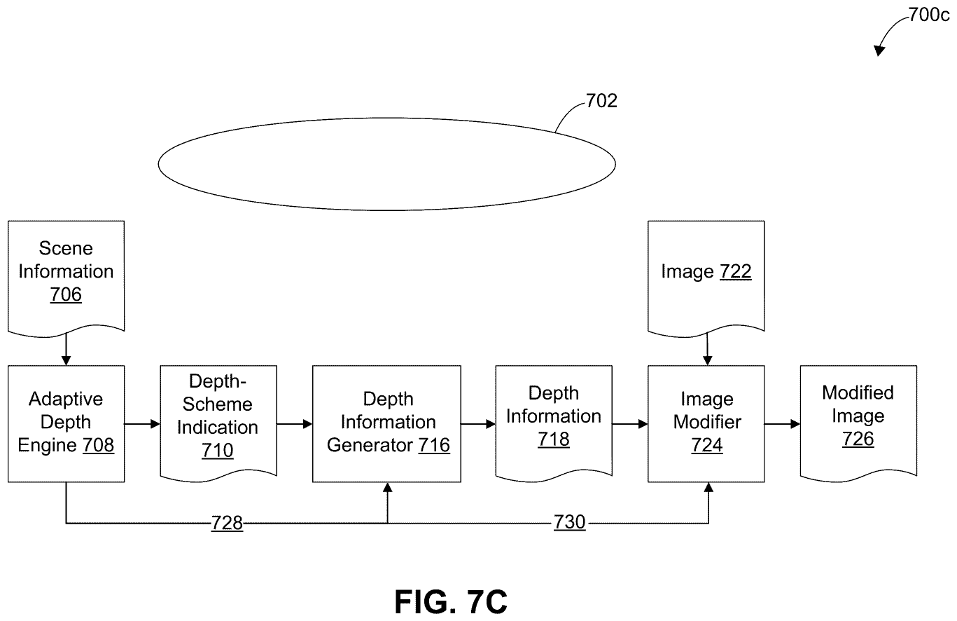

FIG. 7A is a block diagram illustrating an example system 700a that may adaptively determine a depth scheme to use to determine depth information 718 of a scene 702, according to various aspects of the present disclosure. For example, system 700a may obtain scene information 706 of scene 702. An adaptive depth engine 708 of system 700a may determine a depth scheme to use to determine depth information 718 based on scene information 706. Adaptive depth engine 708 may provide a depth-scheme indication 710, indicative of the determined depth scheme, to depth information generator 716. Depth information generator 716 of system 700a may generate depth information 718 based on the determined depth scheme. In some aspects, system 700a may obtain an image 722 and image modifier 724 of system 700a may generate a modified image 726 based on image 722 and depth information 718.

FIG. 7B is a block diagram of an example system 700b that may adaptively determine a depth scheme to use to determine depth information 718 of scene 702, according to various aspects of the present disclosure. System 700b may be an example of system 700a of FIG. 7A. System 700b of FIG. 7B includes additional elements that are provided as examples of details that may be used to determine a depth scheme to use to determine depth information 718 of scene 702.

Scene sensor(s) 704 of system 700b may determine scene information 706 of scene 702. Scene sensor(s) 704 may be, or may include, one or more cameras, one or more depth sensors, one or more motion detectors (e.g., inertial measurement units), any combination thereof, and/or other sensor. Further, scene sensor(s) 704 may be, or may include, one or more engines used to process data from sensors to generate information, such as depth-determination engines, depth-confidence-determination engines, confidence-determination engines, local-motion-detection engines, object-detection engines, image-segmentation engines, any combination thereof, and/or other data-determination engine.

Scene information 706 may be indicative of aspects of scene 702, such as the presence of subjects in scene 702, motion of subjects in scene 702, depth information related to the subjects in scene 702, confidences values related to the depth information, motion information of a device used to capture image 722, lighting information of scene 702, etc. Examples of scene information 706 include subject information, subject-depth information, subject-depth-confidence information, depth-confidence information, global-motion information, local-motion information, lighting information, any combination thereof, and/or other information.

Subject information may be based on a subject in scene 702. For example, the subject information may be determined by an object-detection technique. The subject information may be, or may include, a segmentation mask and/or labels indicative of one or more subjects in scene 702. Additionally or alternatively, the subject information may indicate the presence or absence of a subject in scene 702. In the present disclosure, the term subject may refer to a person, animal, object, or other subject of an image.

The subject-depth information may be indicative of a depth of the subject in scene 702. The subject-depth information may be determined according to a depth scheme.

The subject-depth-confidence information may be indicative of a confidence of the subject-depth information. For example, the subject-depth-confidence information may indicate a confidence of the depth scheme in the subject-depth information and/or a confidence with which the subject-depth information may be used. The subject-depth-confidence information may be determined according to the depth scheme that determined the subject-depth information.

The depth-confidence information may be indicative of a confidence of the depth information. The depth-confidence information may be determined according to the depth scheme that determined the depth information. The depth-confidence information may be indicative of a confidence of the depth information (e.g., as a whole) whereas the subject-depth-confidence information may be specific to the subject-depth information (e.g., the depth of the subject).

The global-motion information may be indicative of motion of a system that obtains depth information 718 and/or a system that obtains image 722. For example, the global-motion information may indicate whether the device which determined depth information 718 and/or the device which captured image 722 is moving. Global-motion information may be determined, for example, using one or more inertial measurements units (IMUs).

The local-motion information may be indicative of motion within scene 702. For example, the local-motion information may be indicative of whether one or more objects within scene 702 is moving. Local-motion information may be determined, for example, using an optical-flow technique.

The lighting information may be indicative of lighting within scene 702. For example, the lighting information may indicate how bright scene 702 is generally.

Adaptive depth engine 708 may determine, based on scene information 706, a depth scheme to use to determine depth information 718. Adaptive depth engine 708 may determine the depth scheme to conserve power and/or based on a quality of depth information 718. For example, adaptive depth engine 708 may determine the depth scheme to not use more power than is appropriate for the scene. As another example, adaptive depth engine 708 may determine the depth scheme to generate high-quality depth information 718 based on scene information 706 (such as lighting and/or motion).

The depth scheme may be, or may include, one or more depth modes. For example, adaptive depth engine 708 may determine to use a phase detection (PD) technique to determine depth information 718. Alternatively, adaptive depth engine 708 may determine to use a depth from stereo (DFS) technique to determine depth information 718. As another alternative, adaptive depth engine 708 may determine to use both a PD and a DFS technique to determine depth information 718. Depth-scheme indication 710 may be an indication of the determined depth scheme.

Depth sensor(s) 712 of system 700b may generate raw depth data 714 representative of depths to points and/or objects in scene 702. Depth sensor(s) 712 may be, or may include, one or more cameras (e.g., according to a PD technique, such as described with regard to FIG. 1A, according to a DFS technique, such as described with regard to FIG. 2 and FIG. 3, according to a structured light depth-sensing technique, such as described with regard to FIG. 5, and/or according to a machine-learning-model-based technique, such as described with regard to FIG. 6). Additionally or alternatively, depth sensor(s) 712 may be, or may include, one or more projectors or illuminators (e.g., according to a projection-based depth-estimation technique, such as described with regard to FIG. 4 and/or according to a structured light depth-sensing technique, such as described with regard to FIG. 5). Further, depth sensor(s) 712 may include other sensors used to determine depths. Raw depth data 714 may include raw (e.g., not fully processed) depth data from depth sensor(s) 712.

Depth sensor(s) 712 may share sensors with scene sensor(s) 704. For example, the same camera may be used in scene sensor(s) 704 to determine scene information 706 and in depth sensor(s) 712 to determine raw depth data 714.

Depth information generator 716 of system 700b may determine depth information 718 according to depth-scheme indication 710. For example, depth information generator 716 may activate and/or use particular depth modes, based on depth-scheme indication 710, to determine depth information 718. For example, if depth-scheme indication 710 indicates that the depth scheme includes a PD technique, depth information generator 716 may activate a camera of depth sensor(s) 712 and use an image (or images) of the camera to determine depth information 718 (e.g., as described with regard to FIG. 1A). If depth-scheme indication 710 indicates that the depth scheme includes a DFS technique, depth information generator 716 may activate two (or more) cameras of depth sensor(s) 712 and use images of the cameras to determine depth information 718 (e.g., as described with regard to FIG. 2 and FIG. 3). If depth-scheme indication 710 indicates that the depth scheme includes a projection-based technique (such as light detection and ranging (LIDAR), time of flight (ToF) or radio detection and ranging (RADAR)), depth information generator 716 may activate appropriate projectors and sensors of depth sensor(s) 712 to determine depth information 718 (e.g., as described with regard to FIG. 4). If depth-scheme indication 710 indicates that the depth scheme includes a structured-light-based technique, depth information generator 716 may activate an illuminator and a camera to determine depth information 718 (e.g., as described with regard to FIG. 5). If depth-scheme indication 710 indicates that the depth scheme includes a machine-learning-model-based technique, depth information generator 716 may activate a camera and a machine-learning model to determine depth information 718 (e.g., as described with regard to FIG. 6).

In some cases, the depth scheme may include two or more depth modes. In such cases, depth information generator 716 may determine depth information 718 based on raw depth data 714 from the two or more depth modes. For example, depth information generator 716 may average depth values from the two or more depth modes. In some cases, depth information generator 716 may perform a weighted average between the depth modes, for example, based on confidence values of the depths and/or confidence values of the depth modes.

Camera 720 of system 700b may capture image 722 of scene 702. Camera 720 may be included in scene sensor(s) 704 and/or depth sensor(s) 712. For example, camera 720 may be used to generate scene information 706, raw depth data 714, and image 722. Scene information 706 and/or raw depth data 714 may be based on image 722. For example, objects may be detected in image 722. The objects may be part of scene information 706. Further, raw depth data 714 may be based on image 722 (e.g., according to a PD technique, a DFS technique, and/or a machine-learning-model-based technique).

Image modifier 724 may modify image 722 based on depth information 718 to generate modified image 726. For example, image modifier 724 may implement an artificial green screen in image 722 based on depth information 718. As another example, image modifier 724 may implement artificial bokch in image 722 based on depth information 718. As yet another example, image modifier 724 may modify color or intensity values of image 722 based on depth information 718.

FIG. 7C is a block diagram of an example system 700c that may adaptively determine a depth scheme to use to determine depth information 718 of scene 702, according to various aspects of the present disclosure. System 700c may be an example of system 700a of FIG. 7A. System 700c of FIG. 7C includes additional elements that are provided as examples of details that may be used to determine a depth scheme to use to determine depth information 718 of scene 702. The additional elements and details described with regard to system 700c may be implemented with the elements and details described with regard to system 700b of FIG. 7B.

In some aspects, adaptive depth engine 708 may determine a depth processing rate 728 based on scene information 706. For example, adaptive depth engine 708 may determine how often depth information generator 716 is to generate depth information 718 based on scene information 706. For example, system 700c may obtain image 722 at a particular frame rate, for example, 30 frame per second (fps), 60 fps, 90 fps, or 120 fps. For example, image 722 may be a frame of video data captured at a particular frame rate. In some situations, adaptive depth engine 708 may determine that depth information generator 716 is to generate depth information 718 at a rate that matches the rate at which system 700c obtains image 722. In other cases, adaptive depth engine 708 may determine to cause depth information generator 716 to generate depth information 718 at another rate.

For example, based on scene information 706 indicating that scene 702 is stable, adaptive depth engine 708 may determine to cause depth information generator 716 to generate depth information 718 at a rate that is slower than a rate at which image 722 is obtained. Because scene 702 is stable, the depths of points in scene 702 may not change between a first time when a first instance of image 722 is obtained and a second time when a second instance of image 722 is obtained. As such, depth information 718 may be accurate for the first time and the first instance of image 722 and for the second time and the second instance of image 722. In such situations, system 700c may conserve computational resources by not generating new depth information 718 at the same rate at which image 722 is obtained.

For instance, system 700c may obtain instances of image 722 at a rate of 60 fps. Adaptive depth engine 708 may determine that scene 702 is stable, or that changes in scene 702 are slow based on scene information 706. Further, adaptive depth engine 708 may determine to cause depth information generator 716 to generate depth information 718 at a rate of 30 fps (e.g., to generate one instance of depth information 718 for every two instances of image 722).

Image modifier 724 may modify every instance of image 722, e.g., as they are obtained. Image modifier 724 may modify two instances of image 722 based on one instance of depth information 718. For example, at a first time, system 700c may obtain a first instance of image 722 and a first instance of depth information 718. At a second time (e.g., one sixtieth of a second later than the first time), system 700c may obtain a second instance of image 722. At a third time (e.g., one sixtieth of a second later than the second time), system 700c may obtain a third instance of image 722 and a second instance of depth information 718. At a fourth time (e.g., one sixtieth of a second later than the third time), system 700c may obtain a fourth instance of image 722. Image modifier 724 may modify the first and second instances of image 722 based on the first instance of depth information 718. Image modifier 724 may modify the third and fourth instances of image 722 based on the second instance of depth information 718.

In some aspects, image modifier 724 may interpolate between instances of depth information 718. For example, adaptive depth engine 708 may determine interpolation information 730 and image modifier 724 may interpolate between instances of depth information 718 when generating modified image 726 based on image 722.

For example, adaptive depth engine 708 may determine a portion of scene 702 that changes faster than other portions. Adaptive depth engine 708 may determine interpolation information 730 to indicate the portion of depth information 718 that represent the changing portion of scene 702. For example, if an object in scene 702 is moving, interpolation information 730 may indicate the portion of depth information 718 that represents the moving object.

Image modifier 724 may interpolate between instances of depth information 718 based on interpolation information 730. For example, using the four example times, four example instances of image 722, and two example instances of depth information 718, when modifying the second instances of image 722 based on the first instance of depth information 718, image modifier 724 may interpolate between the first and second instances of depth information 718. In some aspects, image modifier 724 may interpolate based on interpolation information 730. For example, image modifier 724 may interpolate a portion of depth information 718 indicated by interpolation information 730. For instance, image modifier 724 may interpolate based on a moving object indicated by interpolation information 730.

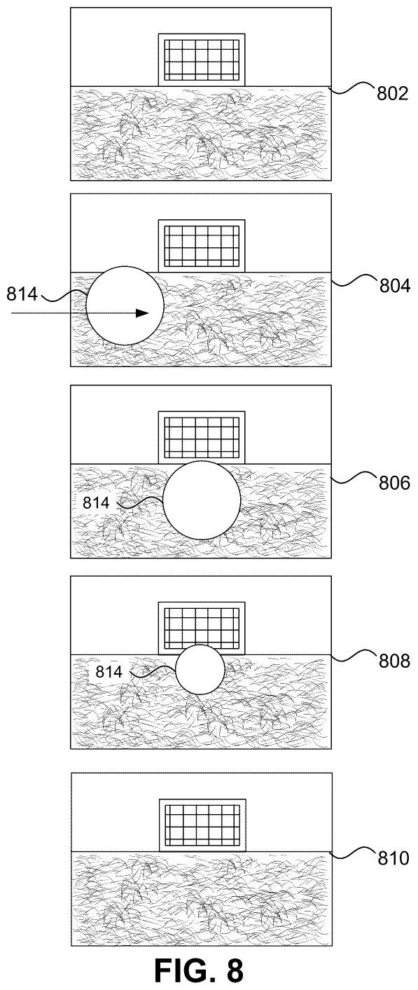

FIG. 8 includes five images of a scene 812 to illustrate various aspects of the present disclosure. For example, FIG. 8 includes an image 802 (e.g., captured at a first time), an image 804 (e.g., captured at a second time), an image 806 (e.g., captured at a third time), an image 808 (e.g., captured at a fourth time), and an image 810 (e.g., captured at a fifth time). The first time, second time, third time, fourth time, and fifth time may be separated by any duration of time. Additionally or alternatively, the first time, second time, third time, fourth time, and fifth time may represent respective a periods of time rather than respective moments in time. The first time, second time, third time, fourth time, and fifth time may be defined, as examples, based on events to illustrate operation of various aspects of the present disclosure.

At the first time there may be no object in scene 812. For example, based on image 802 (or other scene information representing image 802 at substantially the same time image 802 was captured), an object-detection technique may determine that there is no subject in the scene. Based on there being no subject in the scene (e.g., scene information), an adaptive depth engine (e.g., adaptive depth engine 708 of FIG. 7A, FIG. 7B, and/or FIG. 7C) may determine to not use a depth scheme to determine depth information (e.g., based on there being no need to determine depth information because the device is not performing depth-based image-data modification). Not using a depth scheme to determine depths (at the first time) may conserve computational resources.

At the second time, object 814 enters scene (e.g., object 814 enters a field of view of the camera). The object-detection technique may detect object 814. Further, a distance between the camera which captured image 804 and object 814 (e.g., a depth) may be determined. Further still, a confidence value for the depth and/or the depth-determination technique which determined the depth may be determined. Further still, motion of object 814 may be detected and/or quantified. Based on the presence of object 814 in scene, the depth of object 814 in scene 812, the confidence value, and/or the motion of object 814, (e.g., scene information), the adaptive depth engine may determine to use a first depth scheme (e.g., a phase detection (PD) depth-estimation technique) to obtain depth information of scene. For example, based on object 814 being closer than a threshold, based on a confidence related to the depth of object 814, based on a confidence related to the depth-determination technique that determined the depth of object 814, and/or based on how fast object 814 is moving, the adaptive depth engine may determine that a PD depth-estimation technique is appropriate to adequately determine depth information of scene. PD may be a low-cost depth mode that may be appropriate for close objects. The adaptive depth engine may conserve computational resources by selecting PD rather than a more computationally-expensive depth mode.

In some aspects, the adaptive depth engine may further determine, based on the scene information, how frequently to determine depth information of scene. For example, based on how quickly object 814 is moving, the adaptive depth engine may determine a depth processing rate (e.g., depth processing rate 728 of FIG. 7C). As an example, the depth processing rate may be 30 frames per second (fps).

At a third time, object 814 may remain stationary in scene. A local-motion-detection technique (e.g., based on optical flow) may determine that object 814 is stationary in one or more images (including image 806). Based on an indication that object 814 is stationary in scene (e.g., scene information), the adaptive depth engine may determine to maintain the depth scheme (e.g., PD) and to reduce a depth processing rate, for example, to 15 fps. In some aspects, the adaptive depth engine may determine interpolation information (e.g., interpolation information 730 of FIG. 7C). The interpolation information may be based on a ratio between a frame-capture rate of video data (e.g., including image 804, image 806, and image 808) and the depth processing rate.

At a fourth time, object 814 may move farther from the camera which captured image 808. It may be determined that the subject has moved farther from the camera based on depth information obtained according to the determined depth scheme (e.g., PD). Based on the subject moving beyond a threshold distance (e.g., scene information), based on a depth confidence relative to object 814 and/or a confidence relative to PD depth detection, the adaptive depth engine may determine to obtain depth information using a second depth scheme (e.g., a depth from stereo (DFS) technique). Additionally or alternatively, based on object 814 moving, the adaptive depth engine may determine to increase the depth processing rate. Using the second depth scheme at the fourth time may improve the depth information obtained at the fourth time.

At a fifth time, object 814 may have left scene (e.g., object 814 may have exited a field of view which captured image 810). Based on there being no subject in scene (e.g., scene information), the adaptive depth engine may determine to not use a depth scheme to determine depth information Not using a depth scheme to determine depths (at the fifth time) may conserve computational resources.

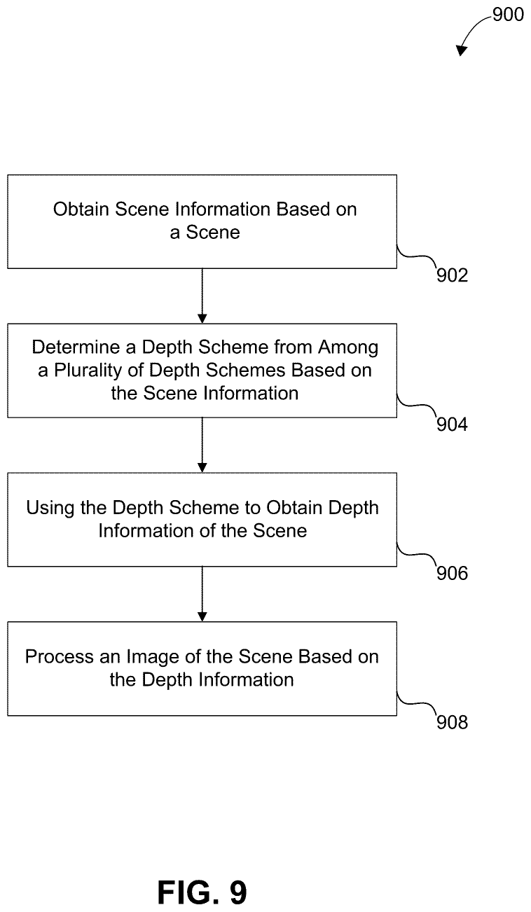

FIG. 9 is a flow diagram illustrating a process 900 for adaptively selecting depth schemes, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 may be implemented as software components that are executed and run on one or more processors.

At block 902, a computing device (or one or more components thereof) may obtain scene information based on a scene. For example, system 700b of FIG. 7B may obtain (e.g., from, or based on data from, scene sensor(s) 704) scene information 706. Scene information 706 may be based on scene 702.

In some aspects, the scene information may be, or may include, information based on an object in the scene; information indicative of a confidence of the depth information; information indicative of motion of a device that obtains the depth information; information indicative of motion within the scene; information indicative of lighting within the scene; information related to of the depth information; or tone/color/tint information related to the scene. For example, scene information 706 may be based on an object in scene 702. In the present disclosure, the term “object” may refer to a person. Additionally or alternatively, scene information 706 may be indicative of a confidence of depth information of scene 702, indicative of motion of depth sensor(s) 712, indicative of motion within scene 702, indicative of lighting within scene 702, tone/color/tint information related to scene 702, and/or information related to depth information of scene 702.

In some aspects, the scene information may be, or may include, information related to a classification of the object; information indicative of motion of the object; information indicative of a depth of the object in the scene; or information indicative of a confidence of the information indicative of the depth of the object in the scene. For example, scene information 706 may be indicative of a classification of an object in scene 702. For example, scene sensor(s) 704 may gather raw data regarding scene 702 (e.g., images of scene 702). A classifier (e.g., a machine-learning model, such as a convolutional neural network (CNN)) may classify one or more objects in the image, and scene information 706 may include the classifications. Additionally or alternatively, scene information 706 may be indicative of motion of the object, a depth of the object in scene 702, and/or indicative of confidence related to the depth of the object in scene 702.

At block 904, the computing device (or one or more components thereof) may determine a depth scheme from among a plurality of depth schemes based on the scene information. For example, adaptive depth engine 708 of FIG. 7B may determine a depth scheme from among a plurality of depth schemes based on depth-scheme indication 710 of FIG. 7B.

In some aspects, to use a depth scheme of the plurality of depth schemes to obtain depth information, the computing device (or one or more components thereof) may obtain the depth information using one or more depth modes, the one or more depth modes comprising at least one of: a phase-detection depth-determination technique; a monocular depth-determination technique; a machine-learning-model-based depth-determination technique; a depth-from-stereo depth-determination technique; or an active-illumination depth-determination technique. For example, adaptive depth engine 708 may determine a depth scheme. The depth schemes may include one or more depth modes such as, a phase-detection depth-determination technique (e.g., as described with regard to FIG. 1); a monocular depth-determination technique (e.g., as described with regard to FIG. 1 or FIG. 6); a machine-learning-model-based depth-determination technique (e.g., as described with regard to FIG. 6); a depth-from-stereo depth-determination technique (e.g., as described with regard to FIG. 2 and FIG. 3); and/or an active-illumination depth-determination technique (e.g., as described with regard to FIG. 4 or FIG. 5).

In some aspects, to determine the depth scheme, the computing device (or one or more components thereof) may determine to obtain the depth information based on two or more depth modes. For example, adaptive depth engine 708 may determine a depth scheme including two or more depth modes, such as, a phase-detection depth-determination technique (e.g., as described with regard to FIG. 1); a monocular depth-determination technique (e.g., as described with regard to FIG. 1 or FIG. 6); a machine-learning-model-based depth-determination technique (e.g., as described with regard to FIG. 6); a depth-from-stereo depth-determination technique (e.g., as described with regard to FIG. 2 and FIG. 3); and/or an active-illumination depth-determination technique (e.g., as described with regard to FIG. 4 or FIG. 5).

At block 906, the computing device (or one or more components thereof) may use the depth scheme to obtain depth information of the scene. For example, depth information generator 716 of FIG. 7B may use a depth scheme (indicated by depth-scheme indication 710) to obtain raw depth data 714 (e.g., using depth sensor(s) 712).

At block 908, the computing device (or one or more components thereof) may process an image of the scene based on the depth information. For example, image modifier 724 of FIG. 7B may process image 722 based on depth information 718.

In some aspects, the scene information may be first scene information based on the scene at a first time. The depth scheme may be a first depth scheme. The depth information may be first depth information obtained by the first depth scheme at a second time. The image may be a first image of the scene. The computing device (or one or more components thereof) may: obtain second scene information based on the scene at a third time; determine a second depth scheme from among the plurality of depth schemes based on the second scene information, wherein the second depth scheme is different than the first depth scheme; use the second depth scheme to obtain second depth information of the scene at a fourth time; and process a second image of the scene based on the second depth information. For example, at a first time, scene sensor(s) 704 of FIG. 7B may obtain first scene information 706. Adaptive depth engine 708 may select a first depth scheme based on the first scene information 706. Depth information generator 716 may generate first depth information 718, at a second time, based on the determined first depth scheme. At a third time, scene sensor(s) 704 may obtain second scene information 706 of scene 702 and adaptive depth engine 708 may determine a second depth scheme based on the second scene information 706. At a fourth time, depth information generator 716 may generate second depth information 718 based on the determined second depth scheme. Further, in some aspects, image modifier 724 may process a first image 722 based on the first depth information 718 and image modifier 724 may process a second image 722 based on the second depth information.

In some aspects, to use the first depth scheme of the plurality of depth schemes to obtain the depth information, the computing device (or one or more components thereof) may obtain the depth information using a first number of depth modes of a plurality of depth modes. To use the second depth scheme of the plurality of depth schemes to obtain depth information, the computing device (or one or more components thereof) may obtain the depth information using a second number of depth modes of the plurality of depth modes. For example, depth information generator 716 may use a first set of depth modes, according to the first determined depth scheme, to determine the first depth information 718. Further, depth information generator 716 may usc a second set of depth modes, according to the second determined depth scheme, to determine the second depth information 718.

In some aspects, the plurality of depth modes include at least two of: a phase-detection depth-determination technique; a monocular depth-determination technique; a machine-learning-model-based depth-determination technique; a depth-from-stereo depth-determination technique; or an active-illumination depth-determination technique. For example, the first and second sets of depth modes of the first and second depth schemes may include depth modes such as, a phase-detection depth-determination technique (e.g., as described with regard to FIG. 1); a monocular depth-determination technique (e.g., as described with regard to FIG. 1 or FIG. 6); a machine-learning-model-based depth-determination technique (e.g., as described with regard to FIG. 6); a depth-from-stereo depth-determination technique (e.g., as described with regard to FIG. 2 and FIG. 3); or an active-illumination depth-determination technique (e.g., as described with regard to FIG. 4 or FIG. 5).

In some aspects, the first number of depth modes may be different from the second number of depth modes. For example, the first number of depth modes of the first depth scheme may include a phase-detection depth-determination technique; and a depth-from-stereo depth-determination technique. The second number of depth modes of the second depth scheme may include the phase-detection depth-determination technique.

In some aspects, the computing device (or one or more components thereof) may modify the image of the scene based on the depth information. For example, image modifier 724 of FIG. 7B may modify image 722 based on depth information 718.

In some aspects, the computing device (or one or more components thereof) may identify foreground pixels of the image based on the depth information, wherein the foreground pixels represent a foreground of the scene; and identify background pixels of the image based on the depth information, wherein the background pixels represent a background of the scene; wherein the image is modified based on the foreground pixels and the background pixels. For example, based on depth information 718, image modifier 724 may determine foreground and background pixels of image 722. Further, image modifier 724 may modify image 722 based on the determined foreground and background pixels of image 722.

In some aspects, the computing device (or one or more components thereof) may adjust, based on the scene information, a rate at which the depth scheme determines the depth information. For example, system 700b of FIG. 7 may adjust a rate at which depth information generator 716 determines depth information 718 based on scene information 706.

In some aspects, the computing device (or one or more components thereof) may interpolate between instances of depth information to generate interpolated depth information. For example, depth sensor(s) 712 may obtain raw depth data 714 at a particular rate. Depth information generator 716 may determine additional depth data, for example, representing depths for times in between the particular rate.

In some aspects, the depth scheme determines the depth information is adjusted separately from an image-capture rate. For example, camera 720 may capture images of scene 702 at a particular frame-capture rate. Additionally, according to the determined depth scheme, depth information generator 716 may generate depth information 718 at a particular depth-capture rate. The depth-capture rate may be independent of the frame capture rate. For example, the depth-capture rate may be different from the frame-capture rate and/or may be determined based on separate factors.

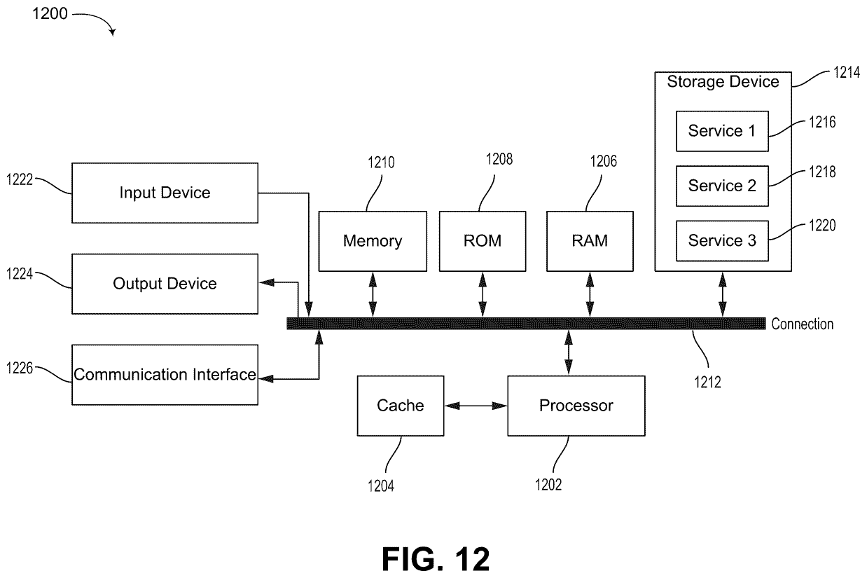

In some examples, as noted previously, the methods described herein (e.g., process 900 of FIG. 9, and/or other methods described herein) can be performed, in whole or in part, by a computing device or apparatus. In one example, one or more of the methods can be performed by system 700a of FIG. 7A, system 700b of FIG. 7B and/or system 700c of FIG. 7C, adaptive depth engine 708 of FIG. 7A, FIG. 7B and FIG. 7C, depth information generator 716 of FIG. 7A, FIG. 7B and FIG. 7C, and/or image modifier 724 of FIG. 7A, FIG. 7B and FIG. 7C or by another system or device. In another example, one or more of the methods (e.g., process 900 of FIG. 9, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 700a, system 700b, system 700c, adaptive depth engine 708, depth information generator 716, and/or image modifier 724 and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

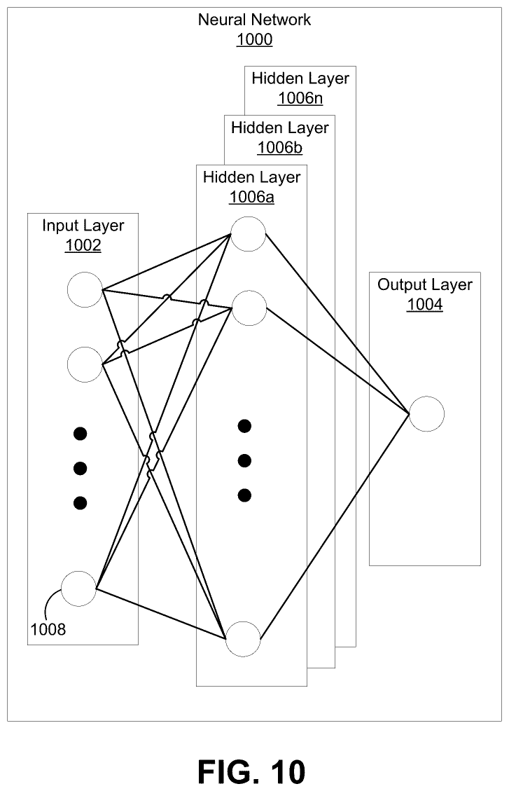

FIG. 10 is an illustrative example of a neural network 1000 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1000 may be an example of, or can implement, machine-learning model 604 of FIG. 6.

An input layer 1002 includes input data. In one illustrative example, input layer 1002 can include data representing image 602 of FIG. 6. Neural network 1000 includes multiple hidden layers, for example, hidden layers 1006a, 1006b, through 1006n. The hidden layers 1006a, 1006b, through hidden layer 1006n include “n” number of hidden layers, where “n” is an integer greater than or equal to one. The number of hidden layers can be made to include as many layers as needed for the given application. Neural network 1000 further includes an output layer 1004 that provides an output resulting from the processing performed by the hidden layers 1006a, 1006b, through 1006n. In one illustrative example, output layer 1004 can provide depth information 606 of FIG. 6.

Neural network 1000 may be, or may include, a multi-layer neural network of interconnected nodes. Each node can represent a piece of information. Information associated with the nodes is shared among the different layers and each layer retains information as information is processed. In some cases, neural network 1000 can include a feed-forward network, in which case there are no feedback connections where outputs of the network are fed back into itself. In some cases, neural network 1000 can include a recurrent neural network, which can have loops that allow information to be carried across nodes while reading in input.

Information can be exchanged between nodes through node-to-node interconnections between the various layers. Nodes of input layer 1002 can activate a set of nodes in the first hidden layer 1006a. For example, as shown, each of the input nodes of input layer 1002 is connected to each of the nodes of the first hidden layer 1006a. The nodes of first hidden layer 1006a can transform the information of each input node by applying activation functions to the input node information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1004, at which an output is provided. In some cases, while nodes (e.g., node 1008) in neural network 1000 are shown as having multiple output lines, a node has a single output and all lines shown as being output from a node represent the same output value.

In some cases, each node or interconnection between nodes can have a weight that is a set of parameters derived from the training of neural network 1000. Once neural network 1000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1000 to be adaptive to inputs and able to learn as more and more data is processed.

Neural network 1000 may be pre-trained to process the features from the data in the input layer 1002 using the different hidden layers 1006a, 1006b, through 1006n in order to provide the output through the output layer 1004. In an example in which neural network 1000 is used to identify features in images, neural network 1000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1000 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1000 is trained well enough so that the weights of the layers are accurately tuned.

For the example of identifying objects in images, the forward pass can include passing a training image through neural network 1000. The weights are initially randomized before neural network 1000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$$E {S}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1000 can include any other deep network other than a CNN, such as an autoencoder, a deep belief nets (DBNs), a Recurrent Neural Networks (RNNs), among others.

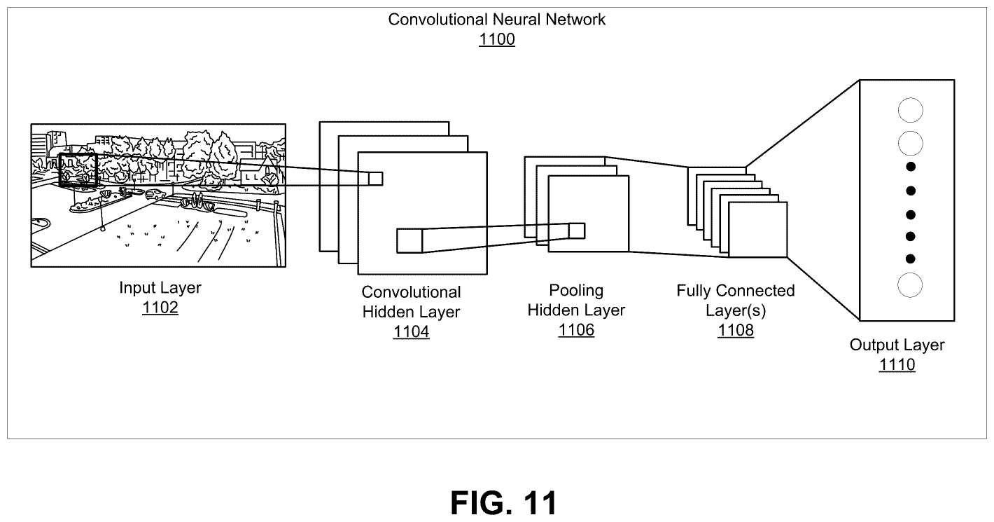

FIG. 11 is an illustrative example of a convolutional neural network (CNN) 1100. The input layer 1102 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1104, an optional non-linear activation layer, a pooling hidden layer 1106, and fully connected layer 1108 (which fully connected layer 1108 can be hidden) to get an output at the output layer 1110. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 can be the convolutional hidden layer 1104. The convolutional hidden layer 1104 can analyze image data of the input layer 1102. Each node of the convolutional hidden layer 1104 is connected to a region of nodes (pixels) of the input image called a receptive field. The convolutional hidden layer 1104 can be considered as one or more filters (each filter corresponding to a different activation or feature map), with each convolutional iteration of a filter being a node or neuron of the convolutional hidden layer 1104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1104. Each connection between a node and a receptive field for that node learns a weight and, in some cases, an overall bias such that each node learns to analyze its particular local receptive field in the input image. Each node of the convolutional hidden layer 1104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1104 is due to each node of the convolutional layer being applied to its corresponding receptive field. For example, a filter of the convolutional hidden layer 1104 can begin in the top-left corner of the input image array and can convolve around the input image. As noted above, each convolutional iteration of the filter can be considered a node or neuron of the convolutional hidden layer 1104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1104.

The mapping from the input layer to the convolutional hidden layer 1104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1104 can include several activation maps in order to identify multiple features in an image. The example shown in FIG. 11 includes three activation maps. Using three activation maps, the convolutional hidden layer 1104 can detect three different kinds of features, with each feature being detectable across the entire image.

In some examples, a non-linear hidden layer can be applied after the convolutional hidden layer 1104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1104.

The pooling hidden layer 1106 can be applied after the convolutional hidden layer 1104 (and after the non-linear hidden layer when used). The pooling hidden layer 1106 is used to simplify the information in the output from the convolutional hidden layer 1104. For example, the pooling hidden layer 1106 can take each activation map output from the convolutional hidden layer 1104 and generates a condensed activation map (or feature map) using a pooling function. Max-pooling is one example of a function performed by a pooling hidden layer. Other forms of pooling functions be used by the pooling hidden layer 1106, such as average pooling, L2-norm pooling, or other suitable pooling functions. A pooling function (e.g., a max-pooling filter, an L2-norm filter, or other suitable pooling filter) is applied to each activation map included in the convolutional hidden layer 1104. In the example shown in FIG. 11, three pooling filters are used for the three activation maps in the convolutional hidden layer 1104.

In some examples, max-pooling can be used by applying a max-pooling filter (e.g., having a size of 2×2) with a stride (e.g., equal to a dimension of the filter, such as a stride of 2) to an activation map output from the convolutional hidden layer 1104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1104 having a dimension of 24×24 nodes, the output from the pooling hidden layer 1106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1106 to every one of the output nodes in the output layer 1110. Using the example above, the input layer includes 28×28 nodes encoding the pixel intensities of the input image, the convolutional hidden layer 1104 includes 3×24×24 hidden feature nodes based on application of a 5×5 local receptive field (for the filters) to three activation maps, and the pooling hidden layer 1106 includes a layer of 3×12×12 hidden feature nodes based on application of max-pooling filter to 2×2 regions across each of the three feature maps. Extending this example, the output layer 1110 can include ten output nodes. In such an example, every node of the 3×12×12 pooling hidden layer 1106 is connected to every node of the output layer 1110.

The fully connected layer 1108 can obtain the output of the previous pooling hidden layer 1106 (which should represent the activation maps of high-level features) and determines the features that most correlate to a particular class. For example, the fully connected layer 1108 can determine the high-level features that most strongly correlate to a particular class and can include weights (nodes) for the high-level features. A product can be computed between the weights of the fully connected layer 1108 and the pooling hidden layer 1106 to obtain probabilities for the different classes. For example, if the CNN 1100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1110 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of camera 102 of FIG. 1A, FIG. 1B, and FIG. 1C, adaptive depth engine 708 of FIG. 7A, FIG. 7B, and FIG. 7C, depth information generator 716 of FIG. 7A, FIG. 7B, and FIG. 7C, and/or image modifier 724 of FIG. 7A, FIG. 7B, and FIG. 7C. Additionally or alternatively, computing-device architecture 1200 may be configured to perform process 900, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing images, the apparatus comprising: at least one memory; and at least one processor coupled to the at least one memory and configured to: obtain scene information based on a scene; determine a depth scheme from among a plurality of depth schemes based on the scene information; use the depth scheme to obtain depth information of the scene; and process an image of the scene based on the depth information.

Aspect 2. The apparatus of aspect 1, wherein the scene information comprises first scene information based on the scene at a first time, the depth scheme comprises a first depth scheme, the depth information comprises first depth information obtained by the first depth scheme at a second time, the image comprises a first image of the scene, and the at least one processor is configured to: obtain second scene information based on the scene at a third time; determine a second depth scheme from among the plurality of depth schemes based on the second scene information, wherein the second depth scheme is different than the first depth scheme; use the second depth scheme to obtain second depth information of the scene at a fourth time; and process a second image of the scene based on the second depth information.

Aspect 3. The apparatus of aspect 2, wherein: to use the first depth scheme of the plurality of depth schemes to obtain the depth information, the at least one processor is configured to obtain the depth information using a first number of depth modes of a plurality of depth modes; and to use the second depth scheme of the plurality of depth schemes to obtain depth information, the at least one processor is configured to obtain the depth information using a second number of depth modes of the plurality of depth modes.

Aspect 4. The apparatus of aspect 3, wherein the plurality of depth modes comprises at least two of: a phase-detection depth-determination technique; a monocular depth-determination technique; a machine-learning-model-based depth-determination technique; a depth-from-stereo depth-determination technique; or an active-illumination depth-determination technique.

Aspect 5. The apparatus of any one of aspects 3 or 4, wherein the first number of depth modes is different from the second number of depth modes.

Aspect 6. The apparatus of any one of aspects 1 to 5, wherein the scene information comprises at least one of: information based on an object in the scene; information indicative of a confidence of the depth information; information indicative of motion of a device that obtains the depth information; information indicative of motion within the scene; information indicative of lighting within the scene; information related to of the depth information; or tone/color/tint information related to the scene.

Aspect 7. The apparatus of aspect 6, wherein the information based on the object comprises at least one of: information related to a classification of the object; information indicative of motion of the object; information indicative of a depth of the object in the scene; or information indicative of a confidence of the information indicative of the depth of the object in the scene.

Aspect 8. The apparatus of any one of aspects 1 to 7, wherein, to use a depth scheme of the plurality of depth schemes to obtain depth information, the at least one processor is configured to obtain the depth information using one or more depth modes, the one or more depth modes comprising at least one of: a phase-detection depth-determination technique; a monocular depth-determination technique; a machine-learning-model-based depth-determination technique; a depth-from-stereo depth-determination technique; or an active-illumination depth-determination technique.

Aspect 9. The apparatus of any one of aspects 1 to 8, wherein, to determine the depth scheme, the at least one processor is configured to determine to obtain the depth information based on two or more depth modes.

Aspect 10. The apparatus of any one of aspects 1 to 9, wherein the at least one processor is configured to modify the image of the scene based on the depth information.

Aspect 11. The apparatus of aspect 10, wherein the at least one processor is configured to: identify foreground pixels of the image based on the depth information, wherein the foreground pixels represent a foreground of the scene; and identify background pixels of the image based on the depth information, wherein the background pixels represent a background of the scene; wherein the image is modified based on the foreground pixels and the background pixels.

Aspect 12. The apparatus of any one of aspects 1 to 11, wherein the at least one processor is configured to adjust, based on the scene information, a rate at which the depth scheme determines the depth information.

Aspect 13. The apparatus of aspect 12, wherein the at least one processor is configured to interpolate between instances of depth information to generate interpolated depth information.

Aspect 14. The apparatus of any one of aspects 12 or 13, wherein the rate at which the depth scheme determines the depth information is adjusted separately from an image-capture rate.

Aspect 15. A method for processing images, the method comprising: obtaining scene information based on a scene; determining a depth scheme from among a plurality of depth schemes based on the scene information; using the depth scheme to obtain depth information of the scene; and processing an image of the scene based on the depth information.

Aspect 16. The method of aspect 15, wherein the scene information comprises first scene information based on the scene at a first time, the depth scheme comprises a first depth scheme, the depth information comprises first depth information obtained by the first depth scheme at a second time, and the image comprises a first image of the scene, the method further comprising: obtaining second scene information based on the scene at a third time; determining a second depth scheme from among the plurality of depth schemes based on the second scene information, wherein the second depth scheme is different than the first depth scheme; using the second depth scheme to obtain second depth information of the scene at a fourth time; and processing a second image of the scene based on the second depth information.

Aspect 17. The method of aspect 16, wherein: using the first depth scheme of the plurality of depth schemes to obtain the depth information comprises obtaining the depth information using a first number of depth modes of a plurality of depth modes; and using the second depth scheme of the plurality of depth schemes to obtain depth information comprises obtaining the depth information using a second number of depth modes of the plurality of depth modes.

Aspect 18. The method of aspect 17, wherein the plurality of depth modes comprises at least two of: a phase-detection depth-determination technique; a monocular depth-determination technique; a machine-learning-model-based depth-determination technique; a depth-from-stereo depth-determination technique; or an active-illumination depth-determination technique.

Aspect 19. The method of any one of aspects 17 or 18, wherein the first number of depth modes is different from the second number of depth modes.

Aspect 20. The method of any one of aspects 15 to 19, wherein the scene information comprises at least one of: information based on an object in the scene; information indicative of a confidence of the depth information; information indicative of motion of a device that obtains the depth information; information indicative of motion within the scene; information indicative of lighting within the scene; information related to of the depth information; or tone/color/tint information related to the scene.

Aspect 21. The method of aspect 20, wherein the information based on the object comprises at least one of: information related to a classification of the object; information indicative of motion of the object; information indicative of a depth of the object in the scene; or information indicative of a confidence of the information indicative of the depth of the object in the scene.

Aspect 22. The method of any one of aspects 15 to 21, wherein using a depth scheme of the plurality of depth schemes to obtain depth information comprises obtaining the depth information using one or more depth modes, the one or more depth modes comprising at least one of: a phase-detection depth-determination technique; a monocular depth-determination technique; a machine-learning-model-based depth-determination technique; a depth-from-stereo depth-determination technique; or an active-illumination depth-determination technique.

Aspect 23. The method of any one of aspects 15 to 22, wherein determining the depth scheme comprises determining to obtain the depth information based on two or more depth modes.

Aspect 24. The method of any one of aspects 15 to 23, further comprising modifying the image of the scene based on the depth information.

Aspect 25. The method of aspect 24, further comprising: identifying foreground pixels of the image based on the depth information, wherein the foreground pixels represent a foreground of the scene; and identifying background pixels of the image based on the depth information, wherein the background pixels represent a background of the scene; wherein the image is modified based on the foreground pixels and the background pixels.

Aspect 26. The method of any one of aspects 15 to 25, further comprising adjusting, based on the scene information, a rate at which the depth scheme determines the depth information.

Aspect 27. The method of aspect 26, further comprising interpolating between instances of depth information to generate interpolated depth information.

Aspect 28. The method of any one of aspects 26 or 27, wherein the rate at which the depth scheme determines the depth information is adjusted separately from an image-capture rate.

Aspect 29. A non-transitory computer-readable storage medium having stored thereon instructions that, when executed by at least one processor, cause the at least one processor to perform operations according to any of aspects 15 to 28.

Aspect 30. An apparatus for providing virtual content for display, the apparatus comprising one or more means for perform operations according to any of aspects 15 to 28.

What is claimed is:

1. An apparatus for processing images, the apparatus comprising:
at least one memory; and
at least one processor coupled to the at least one memory and configured to:
obtain scene information based on a scene;
determine a depth scheme from among a plurality of depth schemes based on the scene information;
use the depth scheme to obtain depth information of the scene; and
process an image of the scene based on the depth information.

2. The apparatus of claim 1, wherein the scene information comprises first scene information based on the scene at a first time, the depth scheme comprises a first depth scheme, the depth information comprises first depth information obtained by the first depth scheme at a second time, the image comprises a first image of the scene, and the at least one processor is configured to:
obtain second scene information based on the scene at a third time;
determine a second depth scheme from among the plurality of depth schemes based on the second scene information, wherein the second depth scheme is different than the first depth scheme;
use the second depth scheme to obtain second depth information of the scene at a fourth time; and
process a second image of the scene based on the second depth information.

3. The apparatus of claim 2, wherein:
to use the first depth scheme of the plurality of depth schemes to obtain the depth information, the at least one processor is configured to obtain the depth information using a first number of depth modes of a plurality of depth modes; and
to use the second depth scheme of the plurality of depth schemes to obtain depth information, the at least one processor is configured to obtain the depth information using a second number of depth modes of the plurality of depth modes.

4. The apparatus of claim 3, wherein the plurality of depth modes comprises at least two of:
a phase-detection depth-determination technique;
a monocular depth-determination technique;
a machine-learning-model-based depth-determination technique;
a depth-from-stereo depth-determination technique; or
an active-illumination depth-determination technique.

5. The apparatus of claim 3, wherein the first number of depth modes is different from the second number of depth modes.

6. The apparatus of claim 1, wherein the scene information comprises at least one of:
information based on an object in the scene;
information indicative of a confidence of the depth information;
information indicative of motion of a device that obtains the depth information;
information indicative of motion within the scene;
information indicative of lighting within the scene;
information related to of the depth information; or
tone/color/tint information related to the scene.

7. The apparatus of claim 6, wherein the information based on the object comprises at least one of:
information related to a classification of the object;
information indicative of motion of the object;
information indicative of a depth of the object in the scene; or
information indicative of a confidence of the information indicative of the depth of the object in the scene.

8. The apparatus of claim 1, wherein, to use a depth scheme of the plurality of depth schemes to obtain depth information, the at least one processor is configured to obtain the depth information using one or more depth modes, the one or more depth modes comprising at least one of:
a phase-detection depth-determination technique;
a monocular depth-determination technique;
a machine-learning-model-based depth-determination technique;
a depth-from-stereo depth-determination technique; or
an active-illumination depth-determination technique.

9. The apparatus of claim 1, wherein, to determine the depth scheme, the at least one processor is configured to determine to obtain the depth information based on two or more depth modes.

10. The apparatus of claim 1, wherein the at least one processor is configured to modify the image of the scene based on the depth information.

11. The apparatus of claim 10, wherein the at least one processor is configured to:
identify foreground pixels of the image based on the depth information, wherein the foreground pixels represent a foreground of the scene; and
identify background pixels of the image based on the depth information, wherein the background pixels represent a background of the scene;
wherein the image is modified based on the foreground pixels and the background pixels.

12. The apparatus of claim 1, wherein the at least one processor is configured to adjust, based on the scene information, a rate at which the depth scheme determines the depth information.

13. The apparatus of claim 12, wherein the at least one processor is configured to interpolate between instances of depth information to generate interpolated depth information.

14. The apparatus of claim 12, wherein the rate at which the depth scheme determines the depth information is adjusted separately from an image-capture rate.

15. A method for processing images, the method comprising:
obtaining scene information based on a scene;
determining a depth scheme from among a plurality of depth schemes based on the scene information;
using the depth scheme to obtain depth information of the scene; and
processing an image of the scene based on the depth information.

16. The method of claim 15, wherein the scene information comprises first scene information based on the scene at a first time, the depth scheme comprises a first depth scheme, the depth information comprises first depth information obtained by the first depth scheme at a second time, and the image comprises a first image of the scene, the method further comprising:
obtaining second scene information based on the scene at a third time;
determining a second depth scheme from among the plurality of depth schemes based on the second scene information, wherein the second depth scheme is different than the first depth scheme;
using the second depth scheme to obtain second depth information of the scene at a fourth time; and
processing a second image of the scene based on the second depth information.

17. The method of claim 16, wherein:
using the first depth scheme of the plurality of depth schemes to obtain the depth information comprises obtaining the depth information using a first number of depth modes of a plurality of depth modes; and
using the second depth scheme of the plurality of depth schemes to obtain depth information comprises obtaining the depth information using a second number of depth modes of the plurality of depth modes.

18. The method of claim 17, wherein the plurality of depth modes comprises at least two of:
a phase-detection depth-determination technique;
a monocular depth-determination technique;
a machine-learning-model-based depth-determination technique;
a depth-from-stereo depth-determination technique; or
an active-illumination depth-determination technique.

19. The method of claim 17, wherein the first number of depth modes is different from the second number of depth modes.

20. The method of claim 15, wherein the scene information comprises at least one of:
information based on an object in the scene;
information indicative of a confidence of the depth information;
information indicative of motion of a device that obtains the depth information;
information indicative of motion within the scene;
information indicative of lighting within the scene;
information related to of the depth information; or
tone/color/tint information related to the scene.
